(19) United States
(12) Patent Application Publication
(10) Pub. No.: US 2012/0253916 A1
(43) Pub. Date: Oct. 4, 2012

(54) DELIVERING AD-INITIATED EMAILS TO A USER'S VISUAL EMAIL INBOX TO PROVIDE ACCESS TO CONTENT

(75) Inventor: Kalyan Ayloo, Sunnyvale, CA (US)

(73) Assignee: Yahoo! Inc., Sunnyvale, CA (US)

(21) Appl. No.: 13/078,718

(22) Filed: Apr. 1, 2011

(51) Int. Cl. G06Q 30/00; G06F 15/16; G06F 3/01

(52) U.S. Cl. 705/14.35; 715/752; 705/14.39; 705/14.73

(57) ABSTRACT

Techniques are described herein for delivering ad-initiated emails to a user's visual email inbox to provide access to content. Ad-initiated emails are emails that are generated by an ad server in response to a user's selection of an online advertisement that is served by the ad server. A visual email is an email that is represented using a creative. For instance, the visual email may include metadata that identifies the creative or that may be used to identify the creative. The creative may be an audio component, an image component, and/or a video component. A creative may be used to represent a single email or multiple emails. If a creative is used to represent multiple emails, selection of the creative may provide access to the various emails, information identified by the emails, and/or a list of the emails. Content may include a coupon, a file, an advertisement, etc.

### BACKGROUND OF THE INVENTION

1. Field of the Invention

The present invention relates to providing access to content using online ads and visual email.

2. Background

Certain advertisement (“ad”) networks enable ads (e.g., contextual ads, display ads) to be served to users who visit the Web sites of publishers that are participating in the ad network. Advertisers generate the ads and buy placements (a.k.a. inventory) for those ads on the publishers' Web sites usually based on the anticipated audiences for those sites and/or the content of those sites. These ads may be graphical (“display ads”) or textual. A placement represents a publisher's agreement to serve a trafficked (i.e., specified) ad to users when the users visit the publisher's site. The publisher often serves the trafficked display or contextual ad contemporaneously with other content associated with the publisher's site. Similarly, sponsored search advertising systems serve ads (“sponsored ads”) to users that enter queries on search engine websites, often alongside the responses to the queries.

Ad networks typically include ad serving systems that determine which advertisements are to be provided to users. In conventional contextual or display ad networks, when a publisher receives a page view from a user, the publisher sends an ad call to an ad serving system. An ad call is a request for an advertisement. The ad serving system selects an advertisement from an ad inventory based on various factors. The ad serving system then sends the advertisement to the publisher, so that the publisher can serve the advertisement to the user. Sponsored search advertising systems work similarly. When the search engine receives a query from the user, an ad call is sent to the ad serving system, which typically selects an advertisement based on that query.

Conventional techniques for providing access to content, such as coupons or other offers, often involve providing an advertisement that includes a button to a user. When the user selects the button, the user is routed to the advertiser's landing page. Once the user reaches the advertiser's landing page, the user may access the content. For example, the landing page may include the content, or the user may download the content via links that are included in the landing page. However, such conventional techniques typically distract the user from viewing the web site with respect to which the advertisement was shown, which may negatively affect the user's online experience. Moreover, the user may not take an immediate action with regard to the content. For example, if the content includes a coupon, the user may not immediately use the coupon. Accordingly, the user often saves the content to a disk or some other media for later use. When the user is ready to take action with regard to the content, the user may not remember where the content is stored and therefore may encounter some difficulty in retrieving the content.

### BRIEF SUMMARY OF THE INVENTION

Various approaches are described herein for, among other things, delivering ad-initiated emails to a user's visual email inbox to provide access to content. Ad-initiated emails are emails that are generated by an ad server in response to a user's selection of an online advertisement that is served by the ad server. A visual email is an email that is represented using a creative. For instance, the visual email may include metadata that identifies the creative or that may be used to identify the creative. A creative is well known in the relevant art(s) to be a media component (e.g., of an online ad). For example, the creative may be an audio component, an image component, and/or a video component. A creative may be used to represent a single email or multiple emails. If a creative is used to represent multiple emails, selection of the creative may provide access to the various emails, information identified by the emails, and/or a list of the emails. Content may include a coupon or other offer, a file (e.g., a FLASH® file), an advertisement, etc.

An example method is described in which an email interface is provided that includes creatives. Each creative represents a respective seller from which email(s) are received based on selection of respective online advertisement(s) by a user. In a first example, the creatives may be arranged in a grid that includes rows and columns, and each creative may correspond to a respective row and a respective column of the grid. In a second example, the creatives may be arranged in a list (e.g., a single row or a single column). In a third example, the creatives may be arranged in a cover flow, e.g., to enable the user to visually flip through the creatives. Each email includes metadata that identifies a landing page of the seller from which the email is received and/or content regarding the seller from which the email is received. For example, the content may include a coupon for a discount regarding a service and/or a product of the seller from which the email is received, a file (e.g., a FLASH® file) that includes information regarding the seller from which the email is received, an advertisement regarding a service and/or a product of the seller from which the email is received, etc. Each creative is based on the metadata that is included in at least one of the email(s) from the seller that is represented by that creative. Each creative is configured to be selectable by the user, such that selection of that creative by the user initiates access to a landing page and/or content that is identified by an email that is received from the seller that is represented by the creative.

Another example method is described. In accordance with this method, an online advertisement is provided in the context of a web page to a user. The advertisement includes a selectable interface element that corresponds to an offer for a coupon from a seller. A determination is made that the user selects the selectable interface element. An email is provided to an email account of the user in response to determining that the user selects the selectable interface element. The email includes information regarding the coupon.

A system is described that includes an ad server, a store, and an email server. The ad server includes an ad provision module, a determination module, and an email provision module. The ad provision module is configured to provide an online advertisement regarding a seller in the context of a web page to a user, the advertisement including a selectable interface element. The determination module is configured to determine whether the user selects the selectable interface element. The email provision module is configured to provide an email to an email account of the user in response to a determination that the user selects the selectable interface element. The email includes metadata that identifies the seller and that indicates that the email is an ad-initiated email. The store is configured to store at least the online advertisement and creatives. The email server includes an interface module, a retrieval module, and an access module. The interface module is configured to provide an email interface that includes the creatives. In a first example, the creatives may be arranged in a grid that includes rows and columns, and each creative may correspond to a respective row and a respective column of the grid. In a second example, the creatives may be arranged in a list (e.g., a single row or a single column). In a third example, the creatives may be arranged in a cover flow, e.g., to enable the user to visually flip through the creatives. The retrieval module is configured to retrieve a first creative of the creatives from the store based on the metadata identifying the seller and further based on the metadata indicating that the email is an ad-initiated email. The access module is configured to provide access to information that is identified by the email in response to selection of the first creative by the user.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example advertisement (“ad”) network in accordance with an embodiment described herein.

FIGS. 2A and 2B depict respective portions of a flowchart of an example method for providing access to content in accordance with an embodiment described herein.

FIGS. 3 and 5 depict flowcharts of example methods for providing access to coupons in accordance with embodiments described herein.

FIG. 4 is a block diagram of an example implementation of an email server shown in FIG. 1 in accordance with an embodiment described herein.

FIG. 6 is a block diagram of an example implementation of an ad server shown in FIG. 1 in accordance with an embodiment described herein.

FIG. 7 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of delivering ad-initiated emails to a user's visual email inbox to provide access to coupons. Ad-initiated emails are emails that are generated by an ad server in response to a user's selection of an online advertisement that is served by the ad server. A visual email is an email that is represented using a creative. For instance, the visual email may include metadata that identifies the creative or that may be used to identify the creative. A creative is well known in the relevant art(s) to be a media component (e.g., of an online ad). For example, the creative may be an audio component, an image component, and/or a video component. A creative may be used to represent a single email or multiple emails. If a creative is used to represent multiple emails, selection of the creative may provide access to the various emails, information identified by the emails, and/or a list of the emails.

Techniques described herein have a variety of benefits as compared to conventional techniques for providing access to coupons. For instance, the techniques described herein may eliminate a need for a user to manually download such coupons. The techniques may enable the user to persistently view a web site even after the user selects a button that pertains to a coupon in an online advertisement that is provided with respect to the web site. Accordingly, an email regarding the coupon may be delivered to an email account of the user without interrupting the user's viewing of the web site. The coupons may be automatically stored in a designated folder of an inbox of the user's email account for subsequent retrieval, which may avoid introducing spam into a root folder of the inbox. The coupons may be available to the user regardless of the user's location, so long as the user has access to the user's email account. Updating a creative in a visual email account to increase an amount of a discount that is indicated by a coupon may provide a revenue generating opportunity for an ad service provider. Advertisements that are served to users in accordance with the techniques described herein may be characterized by relatively higher conversion rates, as compared to advertisements that are served in accordance with conventional techniques. Conversions may be tracked and attributed to the ad service provider based on users' selection of ads that are provided to those users. Moreover, the techniques described herein may provide a competitive advantage as compared to services such as Groupon®, which send coupons to users via email.

### II. Example Embodiments

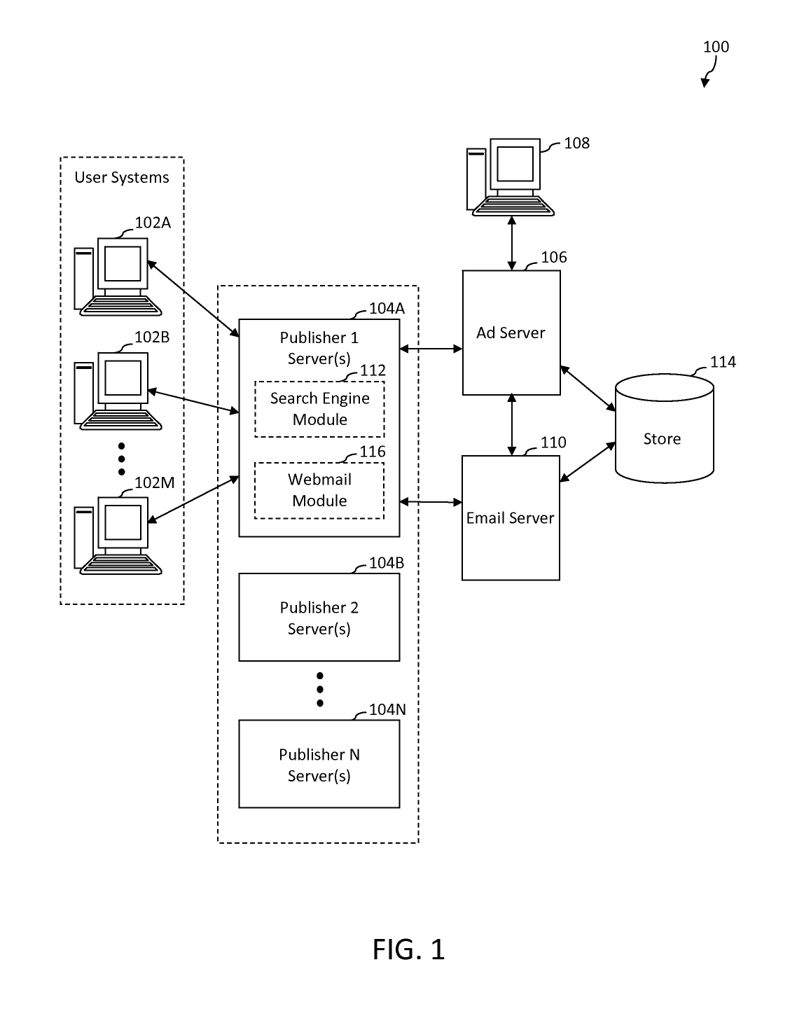

FIG. 1 is a block diagram of an example advertisement (“ad”) network in accordance with an embodiment of the present invention. Generally speaking, ad network 100 operates to serve ads (e.g., contextual ads, sponsored ads, display ads, etc.) provided by advertisers (e.g., sellers of products and/or services) to sites (e.g., Web sites) published by publishers when such sites are accessed by certain users of the network, thereby delivering the ads to the users. In example embodiments, at least some of the ads are selectable by a user. In accordance with these embodiments, when a user selects an ad, an email regarding content (e.g., a coupon or other offer, a file (e.g., a FLASH® file), an advertisement, etc.) is provided to an email account of the user. In some example embodiments, such emails are provided to a visual email inbox of the email account of the user. In accordance with these embodiments, the emails are represented in the visual email inbox using creatives.

As shown in FIG. 1, ad network 100 includes a plurality of user systems 102A-102M, a plurality of publisher servers 104A-104N, an ad server 106, at least one advertiser system 108, an email server 110, and a store 114. Communication among user systems 102A-102M, publisher servers 104A-104N, ad server 106, advertiser system 108, and email server 110 is carried out over a network using well-known network communication protocols. The network may be a wide-area network (e.g., the Internet), a local area network (LAN), another type of network, or a combination thereof.

User systems 102A-102M are computers or other processing systems, each including one or more processors, that are capable of communicating with any one or more of publisher servers 104A-104N. For example, each of user systems 102A-102M may include a client that enables a user who owns (or otherwise has access to) the user system to access sites (e.g., Web sites) that are hosted by publisher servers 104A-104N. For instance, a client may be a Web crawler, a Web browser, a non-Web-enabled client, or any other suitable type of client. By way of example, each of user systems 102A-102M is shown in FIG. 1 to be communicatively coupled to publisher 1 server(s) 104A for the purpose of accessing a site published by publisher 1. Persons skilled in the relevant art(s) will recognize that each of user systems 102A-102M is capable of connecting to any of publisher servers 104A-104N for accessing the sites hosted thereon.

Publisher servers 104A-104N are computers or other processing systems, each including one or more processors, that are capable of communicating with user systems 102A-102M. Each of publisher servers 104A-104N is configured to host a site (e.g., a Web site) published by a corresponding publisher 1-N so that such site is accessible to users of network 100 via user systems 102A-102M. Each of publisher servers 104A-104N is further configured to serve advertisements (e.g., contextual ads, sponsored ads, display ads, etc.) to users of network 100 when those users access a Web site that is hosted by the respective publisher server.

Publisher servers 104A-104N are further configured to execute software programs that provide information to users in response to receiving requests, such as hypertext transfer protocol (HTTP) requests, from users, instant messaging (IM) applications, or web-based email. For example, the information may include Web pages, images, other types of files, output of executables residing on the publisher servers, IM chat sessions, emails, coupons, advertisements, etc. In accordance with this example, the software programs that are executing on publisher servers 104A-104N may provide Web pages that include interface elements (e.g., buttons, widgets, hyperlinks, etc.) that a user may select for accessing the other types of information. The Web pages may be provided as hypertext markup language (HTML) documents and objects (e.g., files) that are linked therein, for example.

One type of software program that may be executed by any one or more of publisher servers 104A-104N is a Web search engine. For instance, publisher 1 server(s) 104A is shown to include search engine module 112, which is configured to execute a Web search engine. Search engine module 112 is capable of searching for information on the World Wide Web (WWW) based on queries that are provided by users. For example, search engine module 112 may search among publisher servers 104A-104N for requested information. Upon discovering instances of information that are relevant to a user's query, search engine module 112 ranks the instances based on their relevance to the query. Search engine module 112 provides a list that includes each of the instances in an order that is based on the respective rankings of the instances. The list may be referred to as the search results corresponding to the query.

Another type of software program that may be executed by any one or more of publisher servers 104A-104N is a Webmail program. For instance, publisher 1 server(s) 104A is shown to include Webmail module 116, which is configured to execute a Webmail program. Webmail module 116 is capable of authenticating and/or authorizing a user when the user attempts to access an email account of the user. Upon authenticating and/or authorizing the user, Webmail module 116 provides the user access to the user's email account. If Webmail module 116 is unable to authenticate and/or authorize the user, Webmail module 116 denies the user access to the user's email account. A variety of techniques for authenticating and/or authorizing a user are known in the relevant art(s).

Search engine module 112 is configured to provide an ad call to ad server 106, upon receiving a query from a user, to request an advertisement (e.g., a sponsored ad) to be provided to the user. Search engine module 112 forwards a user identifier that corresponds to (e.g., that specifies) the user to ad server 106. For example, the user identifier may include a browser cookie of the user or information that is included in the browser cookie. In another example, the user identifier may include a username that is associated with the user. Search engine module 112 may incorporate the user identifier in the ad call or may provide the user identifier in addition to the ad call.

It will be recognized that a search engine module (e.g., search engine module 112) need not necessarily be included in publisher server(s) in order for the publisher server(s) to provide an ad call to ad serving system 1016. For instance, any one or more of publisher servers 104A-104N may provide an ad call to ad server 106 without utilizing a search engine module.

Ad server 106 is a computer or other processing system, including one or more processors, that is capable of serving advertisements (e.g., contextual ads, sponsored ads, display ads, etc.) that are retrieved from store 114 to each of publisher servers 104A-104N when the sites hosted by such servers are accessed by certain users, thereby facilitating the delivery of such advertisements to the users. For instance, ad server 106 may serve advertisement(s) to a publisher server 104 in response to an ad call that is received from that publisher server 104. The ad call may be initiated in response to a query that is provided by a user. Ad server 106 may select an appropriate advertisement to be provided to the user based on a user identifier that is received from search engine module 112.

In example embodiments, at least some of the advertisements that are served by ad server 106 include selectable interface elements (e.g., virtual buttons). In accordance with these embodiments, when a user selects such a selectable interface element, ad server 106 sends an email that includes information regarding content to an email account of the user. Some techniques for handling emails that are sent by ad server 106 are discussed below with reference to email server 110.

By way of example, ad server 106 is shown in FIG. 1 to be communicatively coupled to publisher 1 server(s) 104A for the purpose of serving advertisements to publisher 1. Persons skilled in the relevant art(s) will recognize that ad server 106 is capable of connecting to any of publisher servers 104A-104N for serving advertisements thereto.

Advertiser system 108 is a computer or other processing system, including one or more processors, that is capable of providing advertisements (e.g., contextual ads, sponsored ads, display ads, etc.) and/or creatives to store 114 for storage. A creative is a media component, such as an audio component, an image component, and/or a video component. Although one advertiser system 108 is depicted in FIG. 1, persons skilled in the relevant art(s) will recognize that any number of advertiser systems may be communicatively coupled to ad server 106.

Store 114 stores advertisements that are received from advertiser system 108, so that the advertisements may be retrieved by ad server 106 and served to publisher servers 104A-104N when the sites hosted by the respective servers are accessed by certain users. In addition or alternatively, store 114 stores creatives that are received from advertiser system 108, so that the creatives may be retrieved by email server 110 and included in email interfaces that are provided to publisher servers 104A-104N for presentation when users access their email accounts.

Email server 110 is a computer or other processing system, including one or more processors, that is capable of providing an email interface for each user who accesses his/her email account via Webmail module 116. Each email interface includes creatives, such that each of the creatives represents one or more emails that are directed to the respective user. In a first example, the creatives in each email interface may be arranged in a grid. In a second example, the creatives in each email interface may be arranged in a list (e.g., a single row or a single column). In a third example, the creatives in each email interface may be arranged in a cover flow. In accordance with this example, the cover flow may enable the user to visually flip through the creatives. Each creative may represent a seller from which the respective email(s) are received. In accordance with an example embodiment, the emails, which are represented by the creatives, are received from ad server 106.

It will be recognized that ad network 100 may include a separate email server for each of the publisher server(s) 104A-104N. For instance, email server 110 is shown to be coupled to publisher server(s) 104A, ad server 106, and store 114. Another email server may be coupled to publisher server(s) 104B, ad server 106, and store 114. Yet another email server may be coupled to publisher server(s) 104N, ad server 106, and store 114. Each of the email servers may provide email interfaces for the users who access their email accounts via a corresponding Webmail module of the publisher server(s) to which the respective email server is coupled.

Although advertiser system 108 and user systems 102A-102M are depicted as desktop computers in FIG. 1, persons skilled in the relevant art(s) will appreciate that advertiser system 108 and user systems 102A-102M may include any browser-enabled system or device, including but not limited to a laptop computer, a tablet computer, a personal digital assistant, a cellular telephone, or the like.

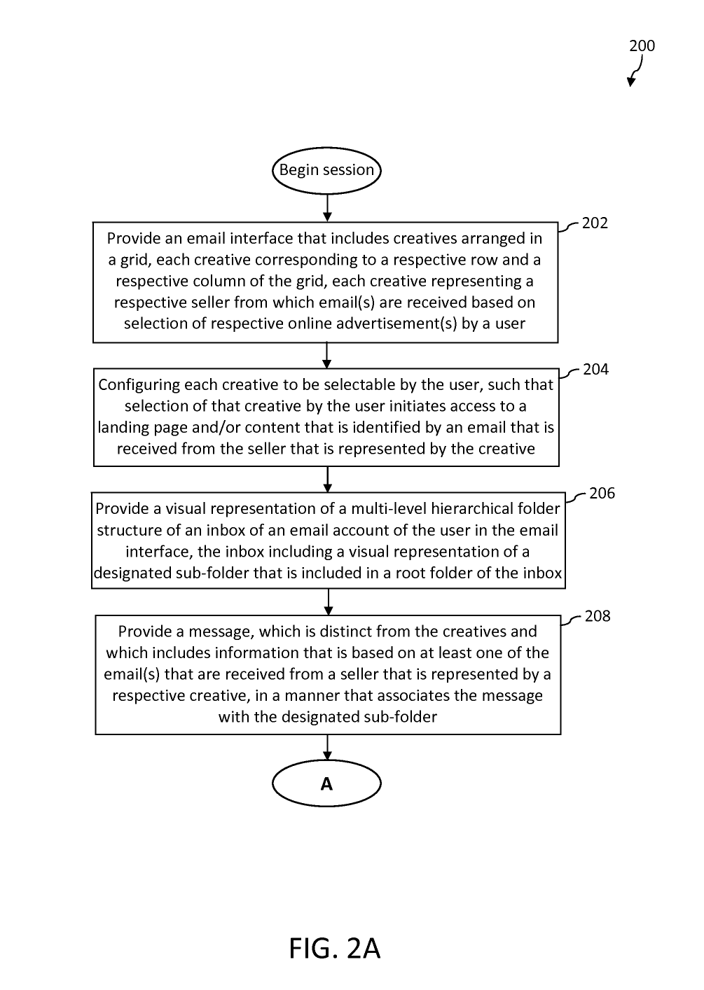

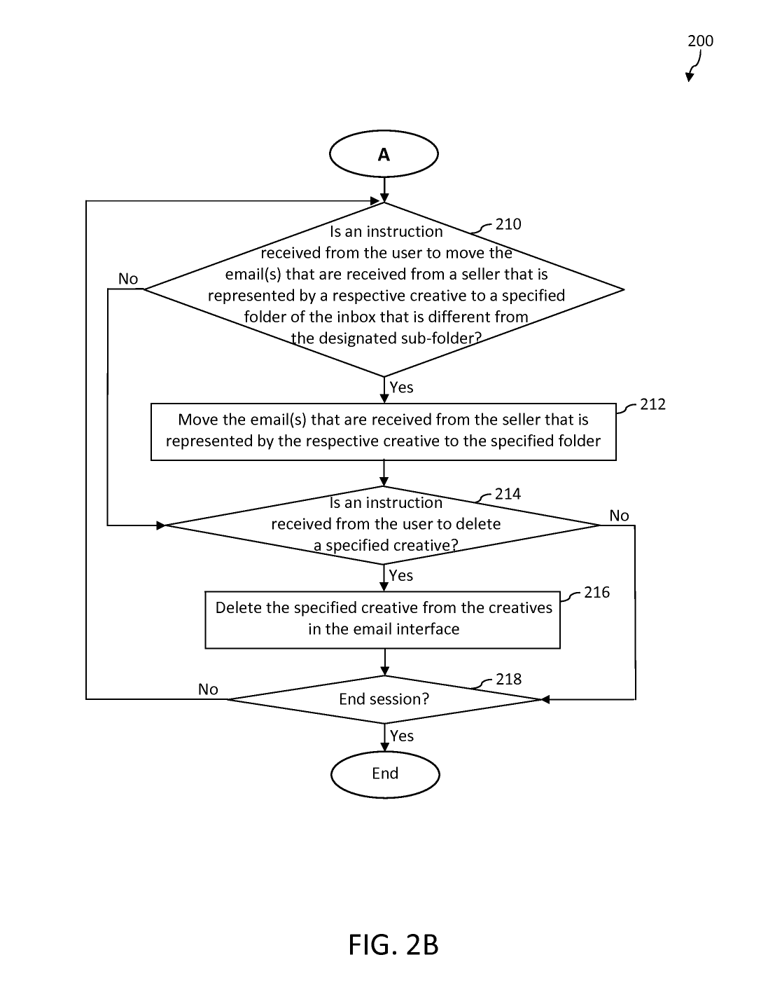

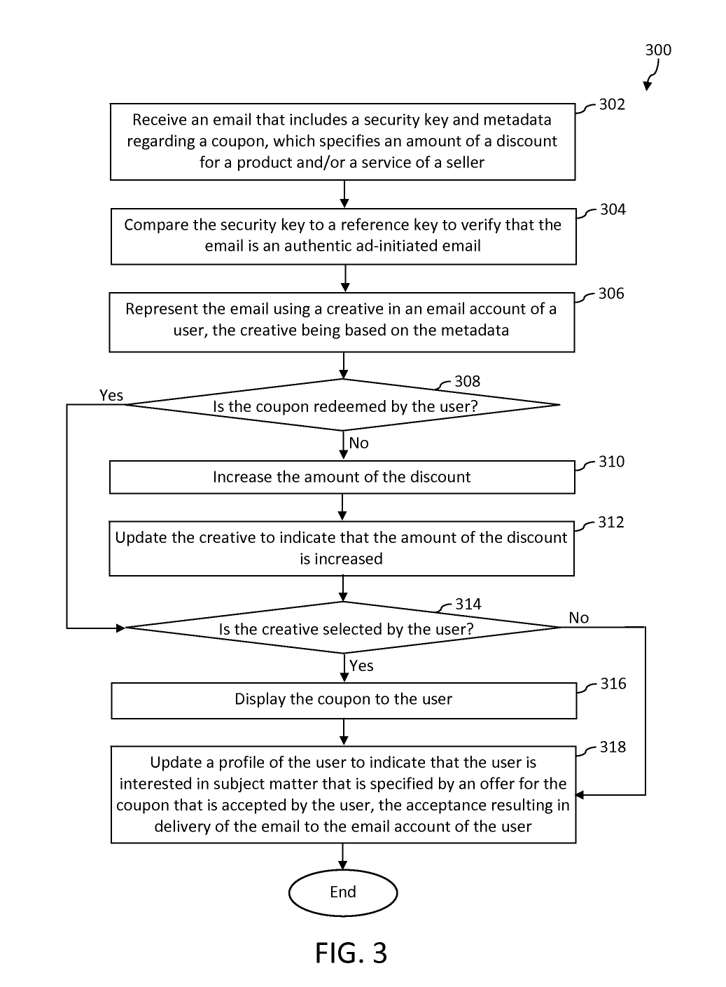

FIGS. 2A and 2B depict respective portions of a flowchart 200 of an example method for providing access to content in accordance with an embodiment described herein. FIG. 3 depicts a flowchart of an example method for providing access to coupons in accordance with an embodiment described herein. Flowcharts 200 and 300 may be performed by email server 110 of ad network 100 shown in FIG. 1, for example. For illustrative purposes, flowcharts 200 and 300 are described with respect to an email server 400 shown in FIG. 4, which is an example of an email server 110, according to an embodiment. As shown in FIG. 4, email server 400 includes a security module 402, an interface module 404, a determination module 406, a moving module 408, a deleting module 410, a storing module 412, a discount changing module 414, an updating module 416, an access module 418, a user profile module 420, and a retrieval module 422. Further structural and operational embodiments will be apparent to persons skilled in the relevant art(s) based on the discussion regarding flowcharts 200 and 300.

The method of flowchart 200 is described as taking place during an email session of a user for illustrative purposes. As shown in FIG. 2A, the method of flowchart 200 begins at step 202. In step 202, an email interface is provided that includes creatives arranged in a grid. Each creative corresponds to a respective row and a respective column of the grid. Each creative represents a respective seller from which email(s) are received based on selection of respective online advertisement(s) by the user. In an example implementation, interface module 404 provides the email interface that includes the creatives arranged in the grid.

It is noted that the creatives are described with reference to step 202 as being arranged in a grid for illustrative purposes. The embodiments are not intended to be limited in this respect. It will be recognized that the creatives may be included in the email interface in any suitable arrangement. For instance, in one embodiment, the creatives are arranged in a list (e.g., a single row or a single column). In another embodiment, the creatives are arranged in a cover flow. In accordance with this embodiment, the cover flow may enable the user to visually flip through the creatives, e.g., in response to a swipe of the user's finger with respect to the email interface.

In some example embodiments, each email includes metadata. For instance, in one example embodiment, each email includes metadata that identifies a seller and that indicates that the email is an ad-initiated email. Each creative may be retrieved from a store (e.g., store 114) based on the metadata in the emails that correspond to that creative identifying the seller that is represented by the creative and indicating that the emails are ad-initiated emails. For example, the metadata in each email may include a uniform resource identifier (RUI), such as a uniform resource locator (URL) or a uniform resource name (URN), that identifies (e.g., points to) a creative to represent a seller from which the email is received. In accordance with this example, the URIs from the emails may be used to retrieve the creatives. In an example implementation, retrieval module 422 retrieves the creatives from the store.

In another example embodiment, each email includes metadata that identifies a landing page of the seller from which the email is received and/or a coupon for a discount regarding a service and/or product of the seller from which the email is received. The metadata in each email may include one or more identifiers (e.g., “message_type=coupon”, “container_type=ad”, “expires_on=12-12-2011”, “shareable=no”, “printable=yes”, “advertiser_id=ford”, “campaign_id=123”, “source=yahoo_finance”, etc.) or other information such as dimensions of a creative that is to represent the seller from which the email is received. In accordance with this embodiment, each creative is based on the metadata that is included in at least one of the email(s) from the seller that is represented by that creative. A discount regarding a service and/or product of a particular seller may (or may not) be transferrable to a service and/or product of another seller. For example, the entire discount may be transferrable to designated seller(s) or all other sellers. In another example, a specified portion (e.g., a threshold percentage or a threshold fixed amount) of the discount may be transferrable to designated seller(s) or all other sellers.

In yet another example embodiment, the email interface is provided such that at least one of the creatives indicates a number of the email(s) from the seller that is represented by the respective creative that include metadata that identifies a coupon from the seller. For instance, at least one of the creatives may indicate a number of emails received from the seller that is represented by the respective creative that include metadata that identifies a coupon from that seller since termination of a most recent session in which the email interface is provided to the user.

In still another example embodiment, the email interface is provided in response to selection of a designated sub-folder of an inbox of an email account of the user. For example, the designated sub-folder may be manually selected by the user once the user obtains access to the inbox. In another example, the designated sub-folder may be automatically selected by interface module 404 when the inbox is presented to the user. In accordance with this embodiment, the designated sub-folder is included in a root folder of the inbox.

In yet another example embodiment, the emails from the various sellers, which are represented by the respective creatives, are stored in the designated sub-folder of the inbox of the email account of the user based on metadata that is included in the emails. For instance, the emails may be automatically stored in the designated sub-folder. In an example implementation, storing module 412 stores the emails from the various sellers in the designated sub-folder. The designated sub-folder may be automatically created upon receipt (at the email account of the user) of the chronologically first email of the emails, which may thereafter be stored in the designated sub-folder. The designated sub-folder may be automatically deleted based on any of a variety of factors. For example, the designated sub-folder may be deleted in response to determining that all of the emails are deleted from the designated sub-folder. In another example, the designated sub-folder may include a last remaining email, which specifies a coupon that is valid for a specified duration of time. In accordance with this example, the designated sub-folder, which includes the last remaining email, may be deleted in response to determining that the specified duration lapses.

At step 204, each creative is configured to be selectable by the user, such that selection of that creative by the user initiates access to a landing page and/or content that is identified by an email that is received from the seller that is represented by the creative. For instance, the content may include a coupon or other offer, a file (e.g., a FLASH® file), an advertisement, etc. In an example implementation, interface module 404 configures each creative to be selectable by the user.

At step 206, a visual representation of a multi-level hierarchical folder structure of the inbox of the email account of the user is provided in the email interface. The inbox includes a visual representation of a designated sub-folder that is included in a root folder of the inbox. In an example implementation, interface module 404 provides the visual representation of the multi-level hierarchical folder structure of the inbox of the email account of the user in the email interface.

At step 208, a message is provided in a manner that associates (e.g., visually and/or audibly associates) the message with the designated sub-folder. The message is distinct from the creatives. For example, the message is not included in any one or more of the creatives. However, the message may partially or fully overlap one or more of the creatives. The message includes information that is based on at least one of the email(s) that are received from a seller that is represented by a respective creative. For example, the message may indicate an increased discount regarding a service and/or product of the seller. In accordance with this example, the increased discount may be determined based on an email that is received from the seller since a most recently terminated email session of the user.

The message may be associated with the designated sub-folder in any of a variety of ways. For example, the message may be displayed proximate (e.g., adjacent to or partially overlapping with) the designated sub-folder. In another example, a visual pointer may extend from the message to the designated sub-folder, or vice versa. In yet another example, the message and the designated sub-folder may have a common visual characteristic. In accordance with this example, the message and the designated sub-folder both may blink, have a common color and/or brightness that distinguishes them from other folders in the inbox, etc. In an example implementation, interface module 404 provides the message in the manner that associates the message with the designated sub-folder. Upon completion of step 208, flow continues at step 210, which is shown in FIG. 2B.

At step 210, a determination is made whether an instruction is received from the user to move the email(s) that are received from a seller that is represented by a respective creative to a specified folder of the inbox. The specified folder is different from the designated sub-folder. For instance, the specified folder may be the root folder of the inbox or a sub-folder of the inbox that is different from the designated sub-folder. In an example implementation, determination module 406 determines whether an instruction is received from the user to move the email(s) to a specified folder of the inbox. If an instruction is received from the user to move the email(s) to a specified folder of the inbox, flow continues to step 212. Otherwise, flow continues to step 214.

At step 212, the email(s) that are received from the seller that is represented by the respective creative are moved to the specified folder. In an example implementation, moving module 408 moves the email(s) to the specified folder.

At step 214, a determination is made whether an instruction is received from the user to delete a specified creative. In an example implementation, determination module 406 determines whether an instruction is received from the user to delete a specified creative. If an instruction is received from the user to delete a specified creative, flow continues to step 216. Otherwise, flow continues to step 218.

At step 216, the specified creative is deleted from the creatives in the email interface. In an example implementation, deleting module 208 deletes the specified creative from the creatives in the email interface.

At step 218, a determination is made whether the email session of the user is to end. For example, the determination may be made in response to an instruction that is received from the user. In an example implementation, determination module 406 determines whether the email session of the user is to end. If the email session of the user is to end, flowchart 200 ends. Otherwise, flow returns to step 210.

Although the method of flowchart 200 is described above as taking place during an email session of a user, it will be recognized that step 204 may take place before the email session of the user begins. Moreover, any one or more of steps 210, 212, 214, and/or 216 of flowchart 200 may take place after the email session of the user ends.

In some example embodiments, one or more steps 202, 204, 206, 208, 210, 212, 214, 216, and/or 218 of flowchart 200 may not be performed. Moreover, steps in addition to or in lieu of steps 202, 204, 206, 208, 210, 212, 214, 216, and/or 218 may be performed.

As shown in FIG. 3, the method of flowchart 300 begins at step 302. In step 302, an email that includes a security key and metadata regarding a coupon is received. The security key indicates that the email is an authentic ad-initiated email. The coupon specifies an amount of a discount for a product and/or a service of a seller. The coupon may specify the amount of the discount in terms of a real or virtual currency. The product and/or service may be a real or virtual product and/or service. It will be recognized that the email is described with reference to step 302 as including a security key for illustrative purposes. The embodiments are not limited in this respect. For instance, the email need not necessarily include the security key. In an example implementation, security module 402 receives the email.

At step 304, the security key is compared to a reference key to verify that the email is an authentic ad-initiated email. In an example implementation, security module 402 compares the security key to the reference key to verify that the email is an ad-initiated email. For instance, security module 402 may determine that the email is an authentic ad-initiated email based on the security key matching (e.g., being the same as) the reference key.

At step 306, the email is represented using a creative in an email account of a user. The creative is based on the metadata. In an example implementation, interface module 404 represents the email using the creative in the email account of the user.

At step 308, a determination is made whether the coupon is redeemed by the user. In an example implementation, determination module 406 determines whether the coupon is redeemed by the user. If the coupon is redeemed by the user, flow continues to step 314. Otherwise, flow continues to step 310.

At step 310, the amount of the discount is increased. In an example implementation, discount change module 412 increases the amount of the discount.

At step 312, the creative is updated to indicate that the amount of the discount is increased. In an example implementation, updating module 416 updates the creative to indicate that the amount of the discount is increased.

At step 314, a determination is made whether the creative is selected by the user. In an example implementation, determination module 406 determines whether the creative is selected by the user. If the creative is selected by the user, flow continues to step 316. Otherwise, flow continues to step 318.

At step 316, the coupon is displayed to the user. In an example implementation, access module 418 displays the coupon to the user.

At step 318, a profile of the user is updated to indicate that the user is interested in subject matter that is specified by an offer for the coupon that is accepted by the user. The acceptance results in delivery of the email to the email account of the user. In an example implementation, user profile module 420 updates the profile of the user to indicate that the user is interested in the subject matter that is specified by the offer for the coupon that is accepted by the user.

In some example embodiments, one or more steps 302, 304, 306, 308, 310, 312, 314, 316, and/or 318 of flowchart 300 may not be performed. Moreover, steps in addition to or in lieu of steps 302, 304, 306, 308, 310, 312, 314, 316, and/or 318 may be performed.

It will be recognized that email server 400 may not include one or more of security module 402, interface module 404, determination module 406, moving module 408, deleting module 410, storing module 412, discount changing module 414, updating module 416, access module 418, user profile module 420, and/or retrieval module 422. Furthermore, email server 400 may include modules in addition to or in lieu of security module 402, interface module 404, determination module 406, moving module 408, deleting module 410, storing module 412, discount changing module 414, updating module 416, access module 418, user profile module 420, and/or retrieval module 422.

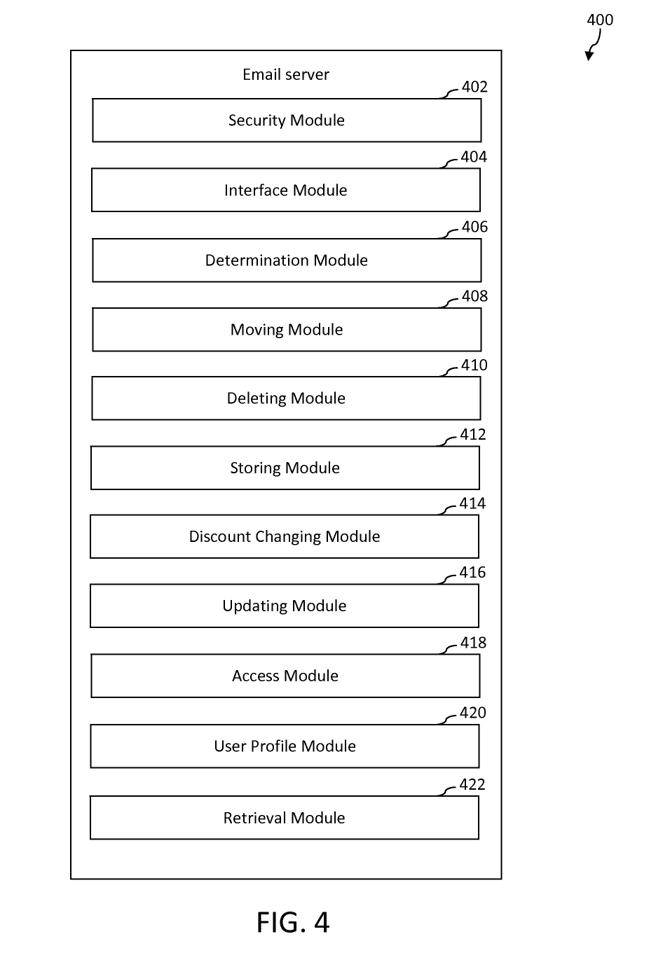

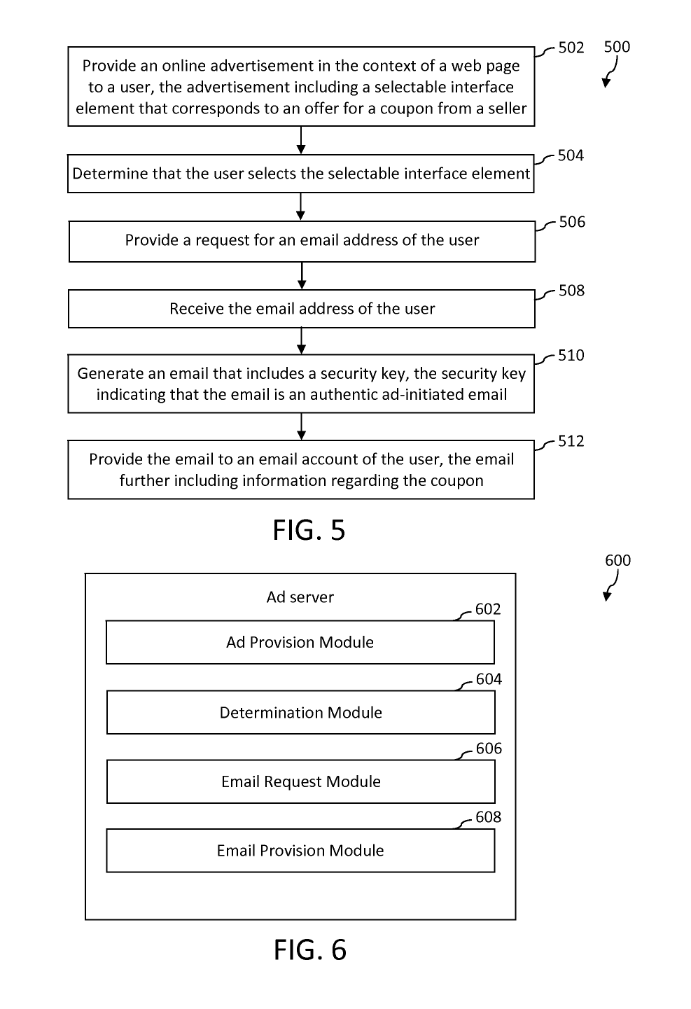

FIG. 5 depicts a flowchart of another example method for providing access to coupons in accordance with an embodiment described herein. Flowchart 500 may be performed by ad server 106 of ad network 100 shown in FIG. 1, for example. For illustrative purposes, flowchart 500 is described with respect to an ad server 600 shown in FIG. 6, which is an example of an ad server 106, according to an embodiment. As shown in FIG. 6, ad server 600 includes an ad provision module 602, a determination module 604, an email request module 606, and an email provision module 608. Further structural and operational embodiments will be apparent to persons skilled in the relevant art(s) based on the discussion regarding flowchart 500.

As shown in FIG. 5, the method of flowchart 500 begins at step 502. In step 502, an online advertisement is provided in the context of a web page to a user. The online advertisement includes a selectable interface element that corresponds to an offer for a coupon from a seller. For instance, the online advertisement may specify information regarding the coupon, such as an expiration date for the coupon, a dollar value of the coupon, a brand to which the coupon pertains, etc. In an example implementation, ad provision module 602 provides the online advertisement in the context of the web page to the user.

In a display ad example, the user may view an online article about cars. In accordance with this example, a display ad from Ford Motor Co. may be provided in the context of the online article. The display ad may include a virtual button and state, “Click this button to receive a $500 discount if you buy a Ford® vehicle within the next week.” It should be noted that the display ad may indicate a specified amount of a virtual currency (e.g., 2000 click bucks) in lieu of the $500 discount.

In a sponsored search ad example, the user may view search results that are provided to the user in response to a search query that pertains to cars. For instance, the search query may include term(s) such as “car”, “auto”, “vehicle”, “purchase”, “etc. In accordance with this example, a sponsored search ad from Ford Motor Co. may be provided in the context of the search results. For purposes of illustration, the sponsored search ad may include the same virtual button and statement, as mentioned in the display ad example above.

At step 504, a determination is made that the user selects the selectable interface element. In an example implementation, determination module 604 determines that the user selects the selectable interface element.

At step 506, a request for an email address of the user is provided. In an example implementation, email request module 606 provides the request for the email address of the user.

At step 508, the email address of the user is received. In an example implementation, email request module 606 receives the email address of the user.

At step 510, an email is generated that includes a security key. The security key indicates that the email is an authentic ad-initiated email. For instance, the security key may be used by an email server (e.g., email server 110 or 400) to verify that the email is an authentic ad-initiated email. In an example implementation, email provision module 608 generates the email to include the security key.

At step 512, the email is provided to an email account of the user. The email further includes information regarding the coupon. In an example implementation, email provision module 608 provides the email to the email account of the user.

It will be recognized that an online advertisement (or a seller that is associated therewith) need not necessarily offer a coupon to a user. In such instances, ad server 600 may provide compensation to the user in response to determining that the user selects a selectable interface element that is included in the online advertisement. The compensation may be in terms of a real or virtual currency. The compensation may be redeemable by the user for real or virtual goods or services. Such goods or services may be provided by the seller, for example.

In some example embodiments, one or more steps 502, 504, 506, 508, 510, and/or 512 of flowchart 500 may not be performed. For example, the email may be automatically provided to the email account of the user at step 512 in response to determining that the user selects the selectable interface element at step 504. For instance, the email address of the user may be determined based on a user name of the user. In accordance with this example, steps 506 and 508 are not performed. Moreover, steps in addition to or in lieu of steps 502, 504, 506, 508, 510, and/or 512 may be performed.

It will be recognized that ad server 600 may not include one or more of ad provision module 602, determination module 604, email request module 606, and/or email provision module 608. Furthermore, ad server 600 may include modules in addition to or in lieu of ad provision module 602, determination module 604, email request module 606, and/or email provision module 608.

### III. Other Example Embodiments

Search engine module 112, Webmail module 116, security module 402, interface module 404, determination module 406, moving module 408, deleting module 410, storing module 412, discount changing module 414, updating module 416, access module 418, user profile module 420, retrieval module 422, ad provision module 602, determination module 604, email request module 606, and email provision module 608 may be implemented in hardware, software, firmware, or any combination thereof. For example, search engine module 112, Webmail module 116, security module 402, interface module 404, determination module 406, moving module 408, deleting module 410, storing module 412, discount changing module 414, updating module 416, access module 418, user profile module 420, retrieval module 422, ad provision module 602, determination module 604, email request module 606, and/or email provision module 608 may be implemented as computer program code configured to be executed in one or more processors. In another example, search engine module 112, Webmail module 116, security module 402, interface module 404, determination module 406, moving module 408, deleting module 410, storing module 412, discount changing module 414, updating module 416, access module 418, user profile module 420, retrieval module 422, ad provision module 602, determination module 604, email request module 606, and/or email provision module 608 may be implemented as hardware logic/electrical circuitry.

### IV. Example Computer Implementation

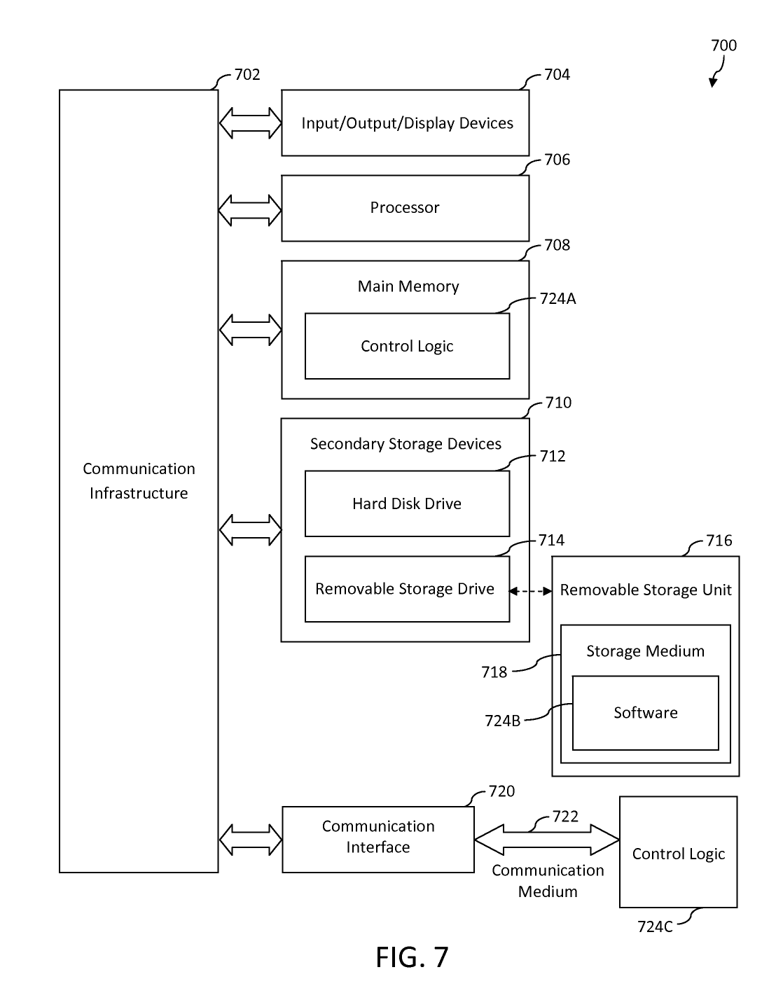

The embodiments described herein, including systems, methods/processes, and/or apparatuses, may be implemented using well known servers/computers, such as computer 700 shown in FIG. 7. For instance, elements of example ad network 100, including any of the user systems 102A-102M, any of the publisher servers 104A-104N, ad server 106, advertiser system 108, and email server 110 depicted in FIG. 1 and elements thereof, each of the steps of flowchart 200 depicted in FIGS. 2A-2B, each of the steps of flowchart 300 depicted in FIG. 3, and each of the steps of flowchart 500 depicted in FIG. 5 can each be implemented using one or more computers 700.

Computer 700 can be any commercially available and well known computer capable of performing the functions described herein, such as computers available from International Business Machines, Apple, Sun, HP, Dell, Cray, etc. Computer 700 may be any type of computer, including a desktop computer, a server, etc.

As shown in FIG. 7, computer 700 includes one or more processors (e.g., central processing units (CPUs)), such as processor 706. Processor 706 may include search engine module 112 and/or Webmail module 116 of FIG. 1; security moduel 402, interface module 404, determination module 406, moving module 408, deleting module 410, storing module 412, discount changing module 414, updating module 416, access module 418, user profile module 420, and/or retrieval module 422 of FIG. 4; ad provision module 602, determination module 604, email request module 606, and/or email provision module 608 of FIG. 6; or any portion or combination thereof, for example, though the scope of the embodiments is not limited in this respect. Processor 706 is connected to a communication infrastructure 702, such as a communication bus. In some embodiments, processor 706 can simultaneously operate multiple computing threads.

Computer 700 also includes a primary or main memory 708, such as a random access memory (RAM). Main memory has stored therein control logic 724A (computer software), and data.

Computer 700 also includes one or more secondary storage devices 710. Secondary storage devices 710 include, for example, a hard disk drive 712 and/or a removable storage device or drive 714, as well as other types of storage devices, such as memory cards and memory sticks. For instance, computer 700 may include an industry standard interface, such as a universal serial bus (USB) interface for interfacing with devices such as a memory stick. Removable storage drive 714 represents a floppy disk drive, a magnetic tape drive, a compact disk drive, an optical storage device, tape backup, etc.

Removable storage drive 714 interacts with a removable storage unit 716. Removable storage unit 716 includes a computer useable or readable storage medium 718 having stored therein computer software 724B (control logic) and/or data. Removable storage unit 716 represents a floppy disk, magnetic tape, compact disc (CD), digital versatile disc (DVD), Blue-ray disc, optical storage disk, memory stick, memory card, or any other computer data storage device. Removable storage drive 714 reads from and/or writes to removable storage unit 716 in a well known manner.

It will be recognized that store 114 of FIG. 1 may be implemented using main memory 708, secondary storage devices 710 (e.g., hard disk drive 712), and/or removable storage unit 716.

Computer 700 also includes input/output/display devices 704, such as monitors, keyboards, pointing devices, etc.

Computer 700 further includes a communication or network interface 720. Communication interface 720 enables computer 700 to communicate with remote devices. For example, communication interface 720 allows computer 700 to communicate over communication networks or mediums 722 (representing a form of a computer useable or readable medium), such as local area networks (LANs), wide area networks (WANs), the Internet, etc. Network interface 720 may interface with remote sites or networks via wired or wireless connections. Examples of communication interface 722 include but are not limited to a modem, a network interface card (e.g., an Ethernet card), a communication port, a Personal Computer Memory Card International Association (PCMCIA) card, etc.

Control logic 724C may be transmitted to and from computer 700 via the communication medium 722.

Any apparatus or manufacture comprising a computer useable or readable medium having control logic (software) stored therein is referred to herein as a computer program product or program storage device. This includes, but is not limited to, computer 700, main memory 708, secondary storage devices 710, and removable storage unit 716. Such computer program products, having control logic stored therein that, when executed by one or more data processing devices, cause such data processing devices to operate as described herein, represent embodiments of the invention.

For example, each of the elements of search engine module 112 and Webmail module 116, each depicted in FIG. 1; security module 402, interface module 404, determination module 406, moving module 408, deleting module 410, storing module 412, discount changing module 414, updating module 416, access module 418, user profile module 420, and retrieval module 422, each depicted in FIG. 4; ad provision module 602, determination module 604, email request module 606, and email provision module 608, each depicted in FIG. 6; each of the steps of flowchart 200 depicted in FIG. 2; each of the steps of flowchart 300 depicted in FIG. 3; and each of the steps of flowchart 500 depicted in FIG. 5 can be implemented as control logic that may be stored on a computer useable medium or computer readable medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, computer readable media, media, is a machine or manufacture defined by 35 U.S.C. §101.

What is claimed is:

1. A method comprising:
providing an email interface that includes a plurality of creatives arranged in a grid that includes a plurality of rows and a plurality of columns, each creative corresponding to a respective row and a respective column of the grid, each creative representing a respective seller from which one or more emails are received based on selection of one or more respective online advertisements by a user, each email including metadata that identifies at least one of a landing page of the seller from which the email is received or a coupon for a discount regarding at least one of a service or a product of the seller from which the email is received, each creative being based on the metadata that is included in at least one of the one or more emails from the seller that is represented by that creative; and
configuring each creative to be selectable by the user, such that selection of that creative by the user initiates access to at least one of a landing page that is identified by an email that is received from the seller that is represented by the creative or a coupon that is identified by an email that is received from the seller that is represented by the creative.

2. The method of claim 1, wherein providing the email interface comprises:
providing the email interface in response to selection of a designated sub-folder of an inbox of an email account of the user, the designated sub-folder being included in a root folder of the inbox.

3. The method of claim 2, further comprising:
receiving an instruction from the user to move the one or more emails that are received from the seller that is represented by a specified creative of the plurality of creatives to a specified folder of the inbox of the email account, the specified folder being different from the designated sub-folder; and
moving the one or more emails that are received from the seller that is represented by the specified creative to the specified folder in response to receiving the instruction.

4. The method of claim 2, further comprising:
providing a visual representation of a multi-level hierarchical folder structure of the inbox that includes a visual representation of the designated sub-folder in the email interface; and
providing a message, which is distinct from the plurality of creatives and which includes information that is based on at least one of the one or more emails that are received from a specified seller that is represented by a respective creative of the plurality of creatives, in a manner that associates the message with the designated sub-folder.

5. The method of claim 1, wherein providing the email interface comprises:
providing the email interface such that at least one of the plurality of creatives indicates a number of the one or more emails from the seller that is represented by the respective creative that include metadata that identifies a coupon from that seller.

6. The method of claim 1, wherein providing the email interface comprises:
providing the email interface such that at least one of the plurality of creatives indicates a number of emails received from the seller that is represented by the respective creative that include metadata that identifies a coupon from that seller since termination of a most recent session in which the email interface is provided to the user.

7. The method of claim 1, further comprising:
receiving an instruction from the user to delete a specified creative of the plurality of creatives; and
deleting the specified creative from the plurality of creatives in the email interface in response to receiving the instruction from the user.

8. A method comprising:
providing an online advertisement in the context of a web page to a user, the advertisement including a selectable interface element that corresponds to an offer for a coupon from a seller;
determining that the user selects the selectable interface element; and
providing an email to an email account of the user in response to determining that the user selects the selectable interface element, the email including information regarding the coupon.

9. The method of claim 8, further comprising:
providing a request for an email address of the user in response to determining that the user selects the selectable interface element; and
receiving the email address of the user;
wherein providing the email comprises:
providing the email to the email account of the user in response to receiving the email address of the user.

10. The method of claim 8, wherein providing the email comprises:
automatically providing the email to the email account of the user in response to determining that the user selects the selectable interface element.

11. The method of claim 8, wherein the email further includes metadata regarding the coupon; and
wherein the method further comprises:
storing the email in a designated sub-folder of an inbox of the email account of the user based on the metadata, the designated sub-folder being included in a root folder of the inbox.

12. The method of claim 11, further comprising:
automatically creating the designated sub-folder upon receipt of the email at the email account of the user.

13. The method of claim 11, wherein the coupon is valid for a specified duration; and
wherein the method further comprises:
determining that the specified duration lapses; and
automatically deleting the designated sub-folder, which includes the email, in response to determining that the specified duration lapses.

14. The method of claim 11, further comprising:
determining that the email is deleted from the designated sub-folder; and
automatically deleting the designated sub-folder in response to determining that the email is deleted from the designated sub-folder.

15. The method of claim 8, wherein the email further includes metadata regarding the coupon; and
wherein the method further comprises:
representing the email using a creative in the email account of the user, the creative being based on the metadata.

16. The method of claim 15, wherein the coupon specifies an amount of a discount for at least one of a product or a service of the seller; and
wherein the method further comprises:
determining that the coupon is not redeemed by the user;
increasing the amount of the discount in response to determining that the coupon is not redeemed by the user; and
updating the creative to indicate that the amount of the discount is increased.

17. The method of claim 15, further comprising:
determining that the creative is selected by the user; and
displaying the coupon to the user in response to determining that the creative is selected by the user.

18. The method of claim 8, further comprising:
updating a profile of the user to indicate that the user is interested in subject matter that is specified by the offer in response to determining that the user selects the selectable interface element.

19. A system comprising:
an ad server that comprises:
an ad provision module configured to provide an online advertisement regarding a seller in the context of a web page to a user, the advertisement including a selectable interface element;
a determination module configured to determine whether the user selects the selectable interface element; and
an email provision module configured to provide an email to an email account of the user in response to a determination that the user selects the selectable interface element, the email including metadata that identifies the seller and that indicates that the email is an ad-initiated email;
a store that stores at least the online advertisement and a plurality of creatives; and
an email server that comprises:
an interface module configured to provide an email interface that includes the plurality of creatives arranged in a grid that includes a plurality of rows and a plurality of columns, each creative corresponding to a respective row and a respective column of the grid, the plurality of creatives including a first creative;
a retrieval module configured to retrieve the first creative from the store based on the metadata identifying the seller and further based on the metadata indicating that the email is an ad-initiated email; and
an access module configured to provide access to information that is identified by the email in response to selection of the first creative by the user.

20. The system of claim 19, wherein the interface module is configured to provide the email interface in response to selection of a designated sub-folder of an inbox of the email account of the user, the designated sub-folder being included in a root folder of the inbox;
wherein the interface module is further configured to provide a visual representation of a multi-level hierarchical folder structure of the inbox that includes a visual representation of the designated sub-folder in the email interface; and
wherein the interface module is further configured to provide a message, which is distinct from the plurality of creatives and which includes information that is based on the email, in a manner that associates the message with the designated sub-folder.
